(19) United States
(12) Patent Application Publication
(10) Pub. No.: US 2006/0129709 A1
(43) Pub. Date: Jun. 15, 2006

(54) Multipurpose scalable server communication link

(75) Inventors: Justin P. Bandholz, Cary, NC (US); John M. Borkenhagen, Rochester, MN (US); Andrew S. Heinzmann, Apex, NC (US); Terry L. Lyon, Rochester, MN (US)

Correspondence Address: IBM CORPORATION;DEPT 917, 3605 HIGHWAY 52 NORTH, ROCHESTER, NY, 55901-7829, US

(73) Assignee: International Business Machines Corporation, Armonk, NY (US)

(21) Appl. No.: 11/008,811

(22) Filed: Dec. 9, 2004

(51) Int. Cl. G06F 3/00

(52) U.S. Cl. 710/30

(57) ABSTRACT

Methods and apparatus that may be utilized to improve the scalability of multi-processor systems are provided. Data packets constructed in accordance with a defined coherence protocol may be encapsulated in standard I/O packets. As a result, the same interconnect fabric may be used to route coherent data traffic and I/O data traffic.

### BACKGROUND OF THE INVENTION

1. Field of the Invention

The present invention generally relates to data processing and, more particularly, to coherent access of memory shared between multiple servers across multiple blades or other physical locations.

2. Description of the Related Art

The term “blade server” generally refers to an entire server designed to fit on a small plug-and-play card or board that can be installed in a rack, side-by-side with other blade servers. Blade servers are thin, compact servers designed to fit in an expandable chassis, enabling users to rapidly assemble and grow computing capacity. Blade servers have captured industry attention because they can replace much larger, more traditional server installations, allowing the consolidation of sprawling server farms into a few super-dense racks. These servers-on-a-card can cut costs by sharing power supplies, expansion cards, and other electronics while offering potentially easier maintenance.

Individual blade servers typically utilize a multi-processor architecture referred to as symmetric multiprocessing. Symmetric multiprocessing (SMP) generally refers to a multiprocessor computing architecture where all processors can access a shared pool of random access memory locations. With multiple processors accessing shared memory locations, coherency may become a concern. Coherency generally refers to the property of shared memory systems in which any shared piece of memory (cache line or memory page) gives consistent values despite (possibly parallel) accesses from different processors.

In order to maintain coherency, each processor may maintain a set of coherency control information (e.g., coherency states) that, for example, may provide an indication of memory locations currently accessed by other processors. Unfortunately, in part due to coherency issues, scaling (increasing the total number of processors) in an SMP system is currently limited to the number of processors that fit on a single blade. To increase scalability beyond the number of processors in a single blade, coherency data needs to be exchanged between multiple blades.

One approach to increase scalability is to use separate interconnect and switching networks (“fabrics”) for coherent memory traffic and I/O traffic, as coherency is not typically a concern with I/O devices. However, separating the coherent and I/O interconnects creates more wires for the blade, interconnect, and backplane which drives up system costs. Another approach is to try to use existing interconnect interfaces, and add more switch ports per processor blade (at least one for coherent traffic and at least one for I/O traffic). Unfortunately, the additional switch ports also drive up system costs. Yet another approach is to process coherent traffic over a proprietary interface. Unfortunately, this approach requires specially designed switch chips with associated development expense and, without significant volume and commodity pricing, these chips may be prohibitively expensive.

Accordingly, a need exists for a technique for efficiently supporting coherent and I/O traffic in a multi-server environment.

### SUMMARY OF THE INVENTION

The present invention generally provides methods and apparatus for supporting coherent and I/O traffic in a multi-server environment across multiple blades or other physical locations.

One embodiment provides a method of maintaining memory coherency in a multi-node system, with each node comprising one or more processors with access to a shared memory pool. The method generally includes encapsulating coherency control information received from a processor at a first node in a header of an input/output (I/O) packet in accordance with an I/O protocol and transmitting the I/O packet to a second node via a switch mechanism compatible with the I/O protocol. In some cases, corresponding coherent data may be included, as a data payload, in the I/O packet. For other cases, for example, when a processor is merely requesting ownership, coherent data may not be included.

Another embodiment provides a method of maintaining memory coherency in a multi-node system, with each node comprising one or more processors with access to a shared memory pool. The method generally includes receiving, by a first one of the nodes, an input/output (I/O) packet from a second one of the nodes, the I/O packet in accordance with an I/O protocol and containing coherency control information encapsulated therein (e.g., in a header), extracting the coherency control information from the I/O packet, and forwarding the coherency control information on to one or more processors on the first node.

Another embodiment provides a communications controller. The communications controller generally includes at least a first input/output (I/O) link comprising a transmitter circuit and a receiver circuit, at least a first coherency protocol engine configured to encapsulate coherency control information from a processor on a first node as a data payload in an I/O packet and transmit the I/O packet to a second node via the transmitter circuit, and at least a first packet router configured to receive an I/O packet via the receiver circuit, extract coherency control information encapsulated in the received I/O packet, and forward the extracted coherency control information to the coherency protocol engine.

Another embodiment provides a server system generally including one or more input/output (I/O) boards, each comprising an I/O controller and one or more I/O devices, a plurality of processor boards, each comprising one or more processors, and an I/O switching mechanism for exchanging I/O packets, in accordance with a defined protocol, between the processor boards and the I/O boards. The system further includes, for each processor board, a communications controller generally configured to exchange I/O packets with I/O boards and other processor boards via the switching mechanism, wherein the controller is configured to encapsulate coherency control information as payload data in I/O messages to be transmitted to other processor boards.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary server system, in accordance with embodiments of the present invention.

FIG. 2 illustrates an exemplary coherency and I/O controller, in accordance with one embodiment of the present invention.

FIGS. 3A and 3B illustrate exemplary operations for routing coherent and I/O traffic, in accordance with one embodiment of the present invention.

FIG. 4 illustrates another exemplary coherency and I/O controller, in accordance with one embodiment of the present invention.

FIG. 5 illustrates another exemplary coherency and I/O controller, in accordance with one embodiment of the present invention.

FIG. 6 illustrates an exemplary computer system with clusters of nodes, in accordance with still another embodiment of the present invention.

### DETAILED DESCRIPTION OF THE PREFERRED EMBODIMENTS

Embodiments of the present invention generally provide methods and apparatus that may be utilized to improve the scalability of multi-processor systems. According to some embodiments, data packets containing data coherency information in accordance with a defined coherence protocol may be encapsulated as in standard I/O packets. For example, data coherency information may be contained as header information of the I/O packets and any corresponding coherent data may be contained as payload data. As a result, the same interconnect fabric may be used to route coherent data traffic and I/O data traffic, which may allow the use of industry standard switching components and reduce overall system cost and development time. The techniques described herein may be utilized to increase scalability of many different types of systems utilizing multiple processor boards, regardless of the exact configuration (e.g., whether a blade or conventional rack configuration).

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

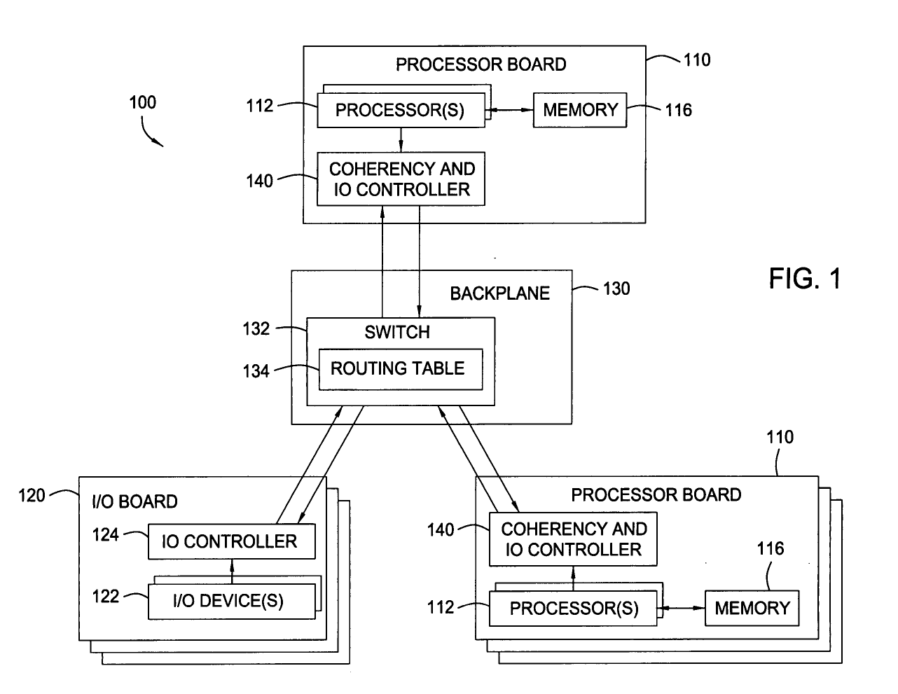

Referring now to FIG. 1, an exemplary server system 100 including one or more processor boards 110 and one or more I/O boards 120 is illustrated, in which embodiments of the present invention may be utilized. The processor boards 110 and I/O boards 120 may be coupled to a backplane 130 that may provide resources shared between the boards. For example, the backplane 130 (or chassis) may include a power supply and cooling components (not shown) shared between the boards. For some embodiments, the processor and I/O boards may be plug and play devices, such as those available in the eServer® BladeCenter™ line of servers available from International Business Machines (IBM) of Armonk, N.Y.

The I/O boards 120 may include an I/O controller 124 to communicate with one or more I/O devices 122. The I/O devices 122 may be any type I/O devices, such as display devices, input devices (e.g., keyboard, mouse, etc.), printing devices, scanning devices, and the like. The processor boards 110 may communicate with (e.g., read data from and write data to) the I/O devices 122 via I/O data packets routed through a switch 132, illustratively integrated with the backplane 130. The switch 132 may support any type of proprietary or industry standard I/O protocol, such as Infiniband, Gigabit Ethernet, FibreChannel, PCI-Express, or any other past or future I/O protocols.

Each processor board 110 may have one or more processors 112, which may each have multiple processor cores, including any number of different type functional units including, but not limited to arithmetic logic units (ALUs), floating point units (FPUs), and single instruction multiple data (SIMD) units. Examples of processors utilizing multiple processor cores include the PowerPC® line of CPUs, available from International Business Machines (IBM) of Armonk, N.Y.

As illustrated, each processor board 110 may also include some amount of memory 116. For some embodiments, the memory available at each processor board 110 may be pooled, effectively presenting to applications a much larger memory space than is actually available at any individual board. With multiple processors 112 from multiple processor boards 110 accessing the same memory locations in such a shared memory pool, for some embodiments, some type of mechanism may be employed to ensure coherency (e.g., so that changes made to a processor's local cache are communicated to other processors, to ensure such changes are reflected in data read from the shared memory pool). According to some coherency schemes, coherency control information may be maintained by each processor, with the coherency control information providing an indication of the state of data accessed by other processors (e.g., Modified, Exclusive, Shared, or Invalid, according to the MESI protocol). Thus, prior to accessing a memory location, a processor may examine the coherency control information to determine (based on the corresponding coherency state) if another processor is accessing it and, if so, wait until that access is complete or request ownership.

For multiple processors on the same board, coherency protocols (often proprietary) are often used to communicate between processors. As a simple example, such protocols may provide a way for one processor to communicate, via a bus, to other processors via an inter-processor messaging scheme, that a process running on it is processing a set of data that may be needed by a process running on another processor. Via this protocol, when the one processor is through processing the set of data, it may communicate this to the other processor which may then access the set of data and begin its processing.

However, implementing a coherency protocol for communication between processors located on separate processor boards 110 presents a challenge. As previously described, one approach would be to provide a separate interconnect fabric (separate from that used for I/O traffic) dedicated to coherent data traffic. However, the increased number of wires would increase cost and complexity.

### A Multipurpose Server Communication Link

Embodiments of the present invention allow existing interconnect fabric utilized for I/O traffic to communicate coherency control information between processor boards 110 by encapsulating the coherency control information in standard I/O packets. Use of an industry standard I/O protocol allows the use of industry standard switch components, eliminating the need to develop a proprietary switch with its associated development expense and chip cost. For some embodiments, the encapsulation of coherency control information into (and subsequent extraction from) I/O packets may be performed by a coherency and I/O controller 140 contained in (or otherwise accessible to) each of the processor boards 110.

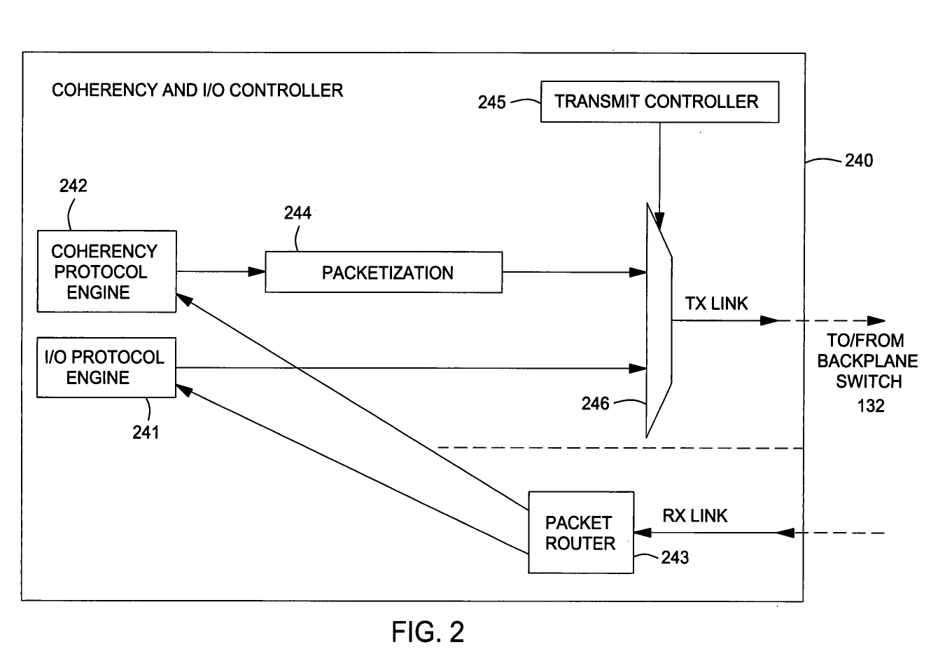

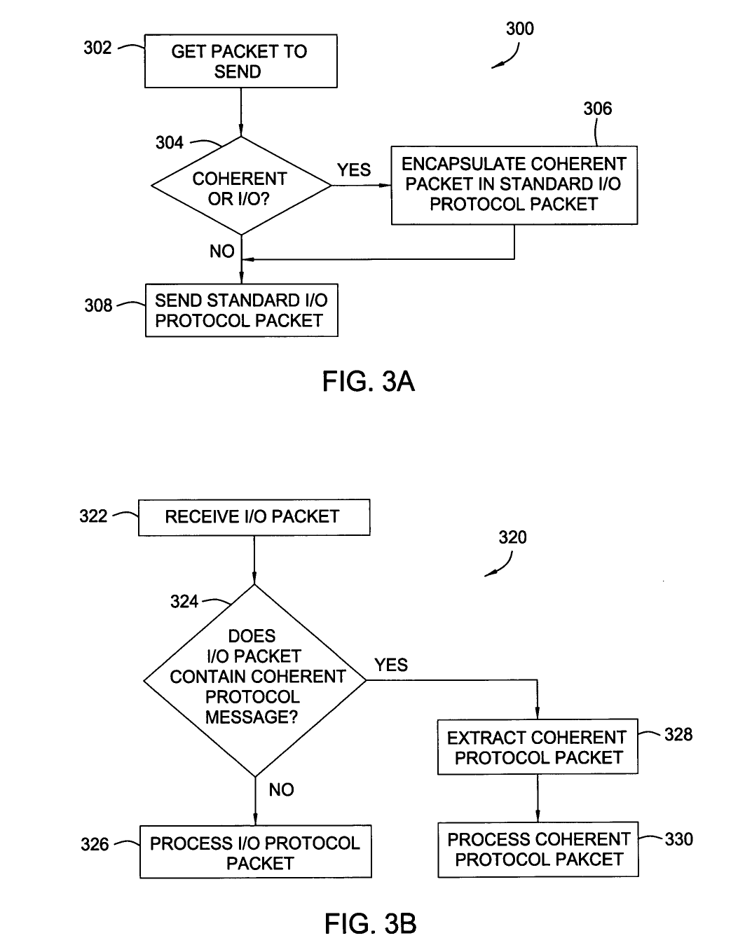

One example of a coherency and I/O controller 240 is shown in FIG. 2. As illustrated, the controller 240 may include an I/O protocol engine 241 and coherency protocol engine 242. Operation of the controller 240 may be described with simultaneous reference to FIG. 2 and to FIGS. 3A and 3B, which illustrate exemplary operations 300 and 320 for transmitting and sending packets, respectively.

As illustrated in FIG. 3A, when the controller 240 receives a packet to send (e.g., from a processor 112), at step 302, it first determines whether the packet is an I/O packet or a coherency packet. When sending I/O data packets, the I/O protocol engine 241 may generate an I/O data packet in accordance with a defined I/O protocol supported by the system (e.g., Infiniband, Gigabit Ethernet, FibreChannel, PCI-Express, and the like). The I/O packet may be sent, at step 308, via a transmit (Tx) link 246 coupled with the backplane switch 132 (e.g., via conductive wiring integrated with the backplane).

On the other hand, when sending coherence data packets (e.g., received from one of the processors 112), the controller 240 first encapsulates the corresponding coherency control information in the I/O packet header (and, if data is being sent, the coherent data as data payload) in a standard I/O protocol message, at step 306. For example, the coherency protocol engine 242 may forward the coherency control information to a packetization component 244. The packetization component 244 may encapsulate the coherency control information as header information in an I/O message. Any corresponding coherent data may be encapsulated as a data payload in the I/O message. This standard I/O message may then be sent, at step 308, via the Tx link 246. As illustrated, a transmit controller 245 may control the Tx link 246, for example, to select between I/O messages received from the I/O protocol engine 241 and I/O messages with encapsulated coherency control information received from the packetization component 244.

Some industry standard protocols, such as Infiniband and Advanced Switching Interconnect (ASI), support a method for encapsulation of proprietary messages that are correctly routed with industry standard switches. Referring back to FIG. 1, the switch 132 will inspect incoming packets and route them to the destination as determined by header information contained in the packet and a routing table 134 within the switch. Therefore, when generating an I/O message encapsulating the coherency control information, the packetization component 244 may include this coherency control information and any other appropriate header information to ensure the packet is routed to other processor boards 110 so they may be updated with the coherency control information (and possibly coherent data) encapsulated therein.

As illustrated in FIG. 3B, when receiving an I/O packet, at step 322, the controller 240 determines whether the packet contains coherency control information, at step 324. If the received packet does not contain an encapsulated coherency packet, the received packet is processed as a normal I/O packet (e.g., a response sent from an I/O board 120), at step 326. If the received packet does contain an encapsulated coherency packet, the coherency packet (coherency control information and possibly coherent data) is extracted, at step 328, and processed, at step 330, for example, by forwarding the extracted packet on to the processors 112 via the coherency protocol engine 242. For some embodiments, a packet router 243 may be configured to examine header information of received packets to determine whether or not they contain coherency data and, based on the determination, route the received packets to the I/O protocol engine 241 or extract the coherency packets and route them to the coherency protocol engine 242.

### Multiple Multipurpose Communications Links

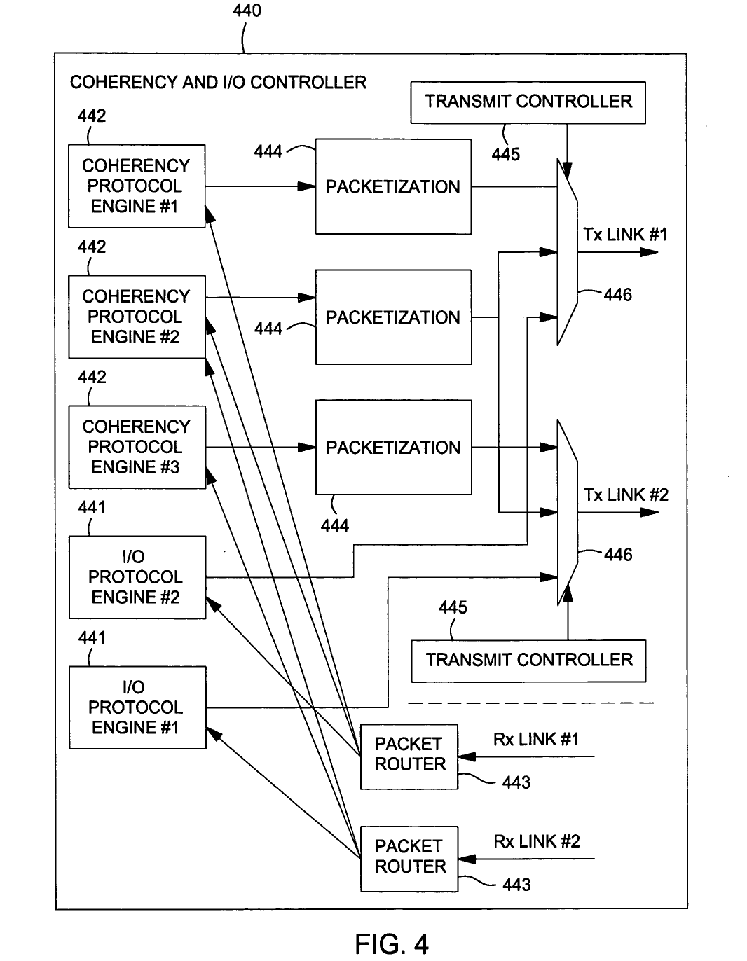

As illustrated in FIG. 4, for some embodiments, multiple multipurpose communications links may be provided in a single coherency and I/O controller 440. As illustrated, each link may include a receive link 443 and a transmit link 446 (controlled by a transmit controller 445) to route packets to/from a plurality of I/O protocol engines 441 and coherency protocol engines 442. Illustratively, three coherency protocol engines 442 and packetization components 444, as well as two I/O protocol engines 441, are provided. However, the actual number and type of protocol engines 441-442 assigned to each link may be varied, for example, depending on the needs of particular applications.

In addition to providing increased bandwidth, the multiple links may also provide redundancy and failure resiliency when a single link is not functioning properly. The multiple links may also allow for optimizations and better utilization of bandwidth. For example, allowing communication packets (either coherency and/or I/O) to optionally be sent over either link allows the flexibility to redirect traffic to a link that is less utilized. In the illustrated example, only the coherency protocol engine #2 shown in FIG. 4 is coupled to both transmit links 446. For some embodiments, the I/O engines 441 and coherency engines 442 may be configured to monitor the amount of traffic on each link and route packets to the less utilized link.

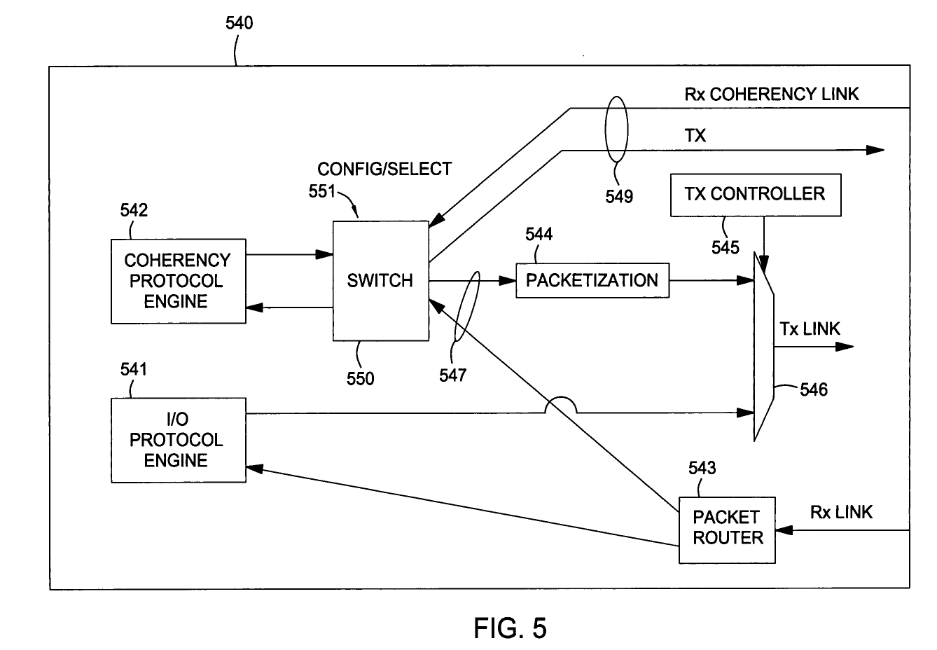

As illustrated in FIG. 5, for some embodiments, a coherency and I/O controller 540 may provide users with the option to separate out the coherency traffic and I/O traffic, for example, allowing a single coherency controller design to be used in systems that scale, as described herein, as well as in traditional SMP systems. As illustrated, some type of switching mechanism 550 may allow coherency traffic to either be routed to the standard I/O link via lines 547 or to a dedicated coherency link 549.

For example, based on a first state of a configuration/select signal 551 (e.g., changeable in hardware or software), the switch may route transmitted coherency packets through the packetization component 544 and receive extracted coherency data packets from the packet router 543. Based on a second state of the configuration/select signal 551, coherency traffic may be routed to the dedicated coherency link 549. For some embodiments, routing the coherency traffic through the dedication coherency link may reduce the latency of the scalable coherency operations.

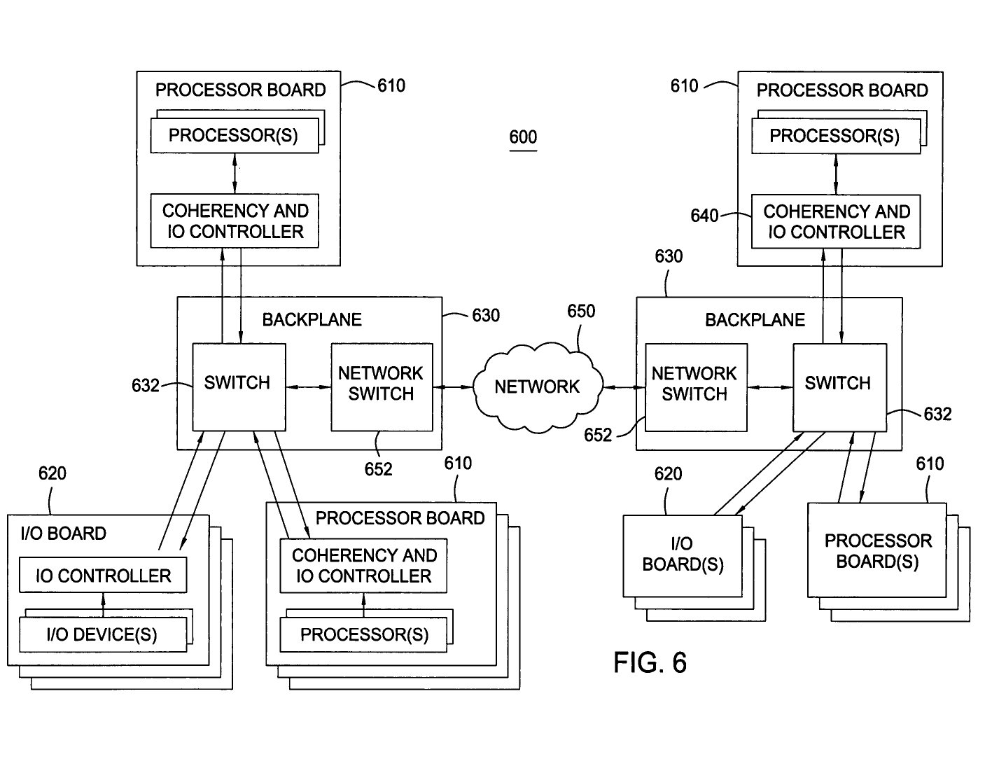

The scalability approach described herein can also be applied to cluster-to-cluster communications. For example, FIG. 6 illustrates an exemplary clustered system 600, in which two or more clusters 602 (group of nodes/boards 610-620) are coupled via a network 650. For example, the backplane 630 of each cluster 602 may include some type of network interface/switch 652, allowing boards 610-620 of one cluster to communicate with boards of another cluster. For some embodiments, the network interface/switch 652 may be used to exchange I/O messages between the switches 632 of each cluster 602. As an alternative, boards 610 may communicate directly with the network switch 652, for example, to exchange network packets containing encapsulated coherency data packets across the network 650.

### CONCLUSION

Embodiments of the present invention may be utilized to improve the scalability of multi-processor systems. According to some embodiments, by encapsulating coherency data packets in standard I/O packets (e.g., with coherency control information contained in a header and, possibly coherent data contained as data payload), the same interconnect fabric may be used to route coherent data traffic and I/O data traffic, which may allow the use of industry standard switching components and reduce overall system cost and development time.

While the foregoing is directed to embodiments of the present invention, other and further embodiments of the invention may be devised without departing from the basic scope thereof, and the scope thereof is determined by the claims that follow.

What is claimed is:

1. A method of maintaining memory coherency in a multi-node system, with each node comprising one or more processors with access to a shared memory pool, comprising:
encapsulating coherency control information in an input/output (I/O) packet in accordance with an I/O protocol, the data having been received from a processor at a first node; and
transmitting the I/O packet to a second node via a switch mechanism compatible with the I/O protocol.

2. The method of claim 1, wherein the I/O protocol comprises at least one of:
Infiniband, Gigabit Ethernet, FibreChannel, and PCI-Express protocols.

3. The method of claim 1, wherein encapsulating the coherency control information in the I/O packet comprises generating header information for the I/O packet indicating one or more nodes that are to receive the I/O packet.

4. The method of claim 1, wherein transmitting the I/O packet to a second node comprises:
selecting, from a plurality of I/O links, an I/O link having the least amount of traffic; and
transmitting the I/O packet to the second node via the selected link.

5. The method of claim 1, wherein transmitting the I/O packet to a second node comprises generating a control signal having a first state to select, as an input to a transmit link, the I/O packet with the encapsulated coherency control information.

6. The method of claim 5, further comprising generating a control signal having a second state to select, as an input to the transmit link, an I/O packet to be transmitted to one or more I/O boards.

7. The method of claim 1, further comprising:
receiving an I/O packet via the switch mechanism;
determining whether the received I/O packet contains coherency control information; and
if so, extracting the coherency control information and forwarding the coherency data on to one or more processors at the first node.

8. The method of claim 1, wherein the first and second nodes are contained in separate clusters of nodes coupled to a network.

9. The method of claim 8, wherein the switching mechanism comprises a network adapter.

10. A method of maintaining memory coherency in a multi-node system, with each node comprising one or more processors with access to a shared memory pool, comprising:
receiving, by a first one of the nodes, an input/output (I/O) packet from a second one of the nodes, the I/O packet in accordance with an I/O protocol and containing coherency control information encapsulated therein;
extracting the coherency control information from the I/O packet; and
forwarding the coherency control information on to one or more processors on the first node.

11. The method of claim 10, further comprising, determining whether the I/O packet contains coherency control information by examining header information contained in the I/O packet.

12. The method of claim 10, wherein the first and second nodes are contained in separate clusters of nodes coupled to a network.

13. The method of claim 12, wherein the switching mechanism comprises a network adapter.

14. A communications controller, comprising:
at least a first input/output (I/O) link comprising a transmitter circuit and a receiver circuit;
at least a first coherency protocol engine configured to encapsulate coherency control information in an I/O packet and transmit the I/O packet to a second node via the transmitter circuit, wherein the coherency control information is received from a processor on a first node; and
at least a first packet router configured to receive an I/O packet via the receiver circuit, extract coherency control information encapsulated in the received I/O packet, and forward the extracted coherency control information to the coherency protocol engine.

15. The controller of claim 14, further comprising:
an I/O protocol engine configured to transmit I/O packets without coherency control information to one or more I/O nodes via the transmitter circuit; and
a transmit controller configured to select, as input to the transmitter circuit, I/O packets from the I/O protocol engine or I/O packets with encapsulated coherency control information from the coherency protocol engine.

16. The controller of claim 14, further comprising:
at least a second input/output (I/O) link comprising a transmitter circuit and a receiver circuit;
at least a second coherency protocol engine configured to encapsulate coherency control information from a processor on a first node in an I/O packet and transmit the I/O packet to a second node via the transmitter circuit of the second I/O link; and
at least a second packet router configured to receive an I/O packet via the receiver circuit of the second I/O link, extract coherency control information encapsulated in the received I/O packet, and forward the extracted coherency control information to the first or second coherency protocol engine.

17. The controller of claim 16, wherein at least two coherency protocol engines are coupled with a common transmitter circuit.

18. The controller of claim 14, further comprising:
at least one coherency link for transmitting coherency control information to at least the second node; and
a switching mechanism for routing coherency control information from the coherency protocol engine to either the coherency link or to a packetizer configured to encapsulate the coherency control information in an I/O message, depending on the state of one or more control signals.

19. A server system, comprising:
one or more input/output (I/O) boards, each comprising an I/O controller and one or more I/O devices;
a plurality of processor boards, each comprising one or more processors;
an I/O switching mechanism for exchanging I/O packets, in accordance with a defined protocol, between the processor boards and the I/O boards; and
for each processor board, a communications controller configured to exchange I/O packets with I/O boards and other processor boards via the switching mechanism, wherein the controller is configured to encapsulate coherency control information in I/O messages to be transmitted to other processor boards.

20. The system of claim 19, wherein:
the communications controller is configured to generate header information in I/O messages encapsulating coherency control information; and
the I/O switching mechanism is configured to examine the header information and, in response, route the I/O messages encapsulating the coherency control information to one or more processor boards.

21. The system of claim 19, wherein the plurality of processor boards comprises processor boards contained in at least a first and second cluster separated by a network connection.

22. The system of claim 21, wherein each cluster has an I/O switching mechanism allowing the exchange of I/O messages encapsulating coherency control information via the network connection.

23. The system of claim 19, wherein the I/O switching mechanism is integrated into a backplane coupled to the I/O and processor boards.

24. The system of claim 19, wherein the communications controller of one or more of the processor boards is capable of being configured to exchange coherency control information via a dedicated communications link rather than via I/O messages encapsulating the coherency control information.

25. The system of claim 19, wherein the communications controller, for at least one of the processor boards, is integrated on the processor board.
